(19) United States
(12) Patent Application Publication
(10) Pub. No.: US 2010/0044253 A1
(43) Pub. Date: Feb. 25, 2010

(54) Sunscreen Storage Device

(76) Inventor: Natalie Santalucia, West Hoxton (AU)

Correspondence Address: MAYBACK & HOFFMAN, P.A., 5722 S. FLAMINGO ROAD #232, FORT LAUDERDALE, FL, 33330, US

(21) Appl. No.: 12/546,908

(22) Filed: Aug. 25, 2009

(30) Foreign Application Priority Data
Aug. 25, 2008 (AU) 2008904354

(51) Int. Cl. B65D 85/00; G04B 47/00

(52) U.S. Cl. 206/210; 368/10; 206/459.1

(57) ABSTRACT

This disclosure relates to a sunscreen storage device comprising a timer that may be used to removably store compacted powder sunscreen contained within pallets.

### CROSS-REFERENCE TO RELATED APPLICATION

This application claims the priority, under 35 U.S.C. §119, of co-pending Australian Provisional Patent Application Serial No. AU2008904354, filed Aug. 25, 2008, the entire disclosure of which is hereby incorporated herein by reference in its entirety.

### STATEMENT REGARDING FEDERALLY SPONSORED RESEARCH OR DEVELOPMENT

n/a

### FIELD OF THE INVENTION

The present invention relates to sun protection and in particular to a sunscreen storage device.

The invention has been developed primarily for use with sun protection and will be described hereinafter with reference to this application. However, it will be appreciated that the invention is not limited to this particular field of use.

### BACKGROUND OF THE INVENTION

Sun protection is a burgeoning consideration around the world, and in particular, in Australasia. Exposure to short length ultraviolet radiation emitted from the sun is harmful. Prolonged and frequent exposure may lead to sunburn, the development of skin cancers such as basal-cell carcinoma, squamous cell carcinoma and melanoma, premature aging and/or marking of the skin. It has been established that these effects may be amplified from prolonged or frequent exposure to harmful ultraviolet radiation at a young age.

The ozone layer, which covers the Earth, absorbs a significant proportion of the harmful wavelengths of ultraviolet radiation emitted from the sun. There is, however, a hole present in the ozone layer, which is situated over Antarctica, through which larger amounts of harmful UV rays may penetrate. As a result, Australia and New Zealand, in particular, receive a larger amount of harmful ultraviolet radiation due to their proximity to the hole in the ozone layer. Thus, sun protection is a particularly problematic issue in these countries.

Sunscreen, topically applied, protects skin from harmful UV rays by absorbing or reflecting UV radiation, or a combination of both. It has been established that reapplication at regular intervals is key to maintaining the effectiveness of sunscreen protection, for example, every two to three hours.

The present invention seeks to provide a sunscreen storage device which will overcome or substantially ameliorate at least some of the deficiencies of the prior art, or to at least provide an alternative.

It is to be understood that, if any prior art information is referred to herein, such reference does not constitute an admission that the information forms a part of the common general knowledge in the art, in Australia or any other country.

### SUMMARY OF THE INVENTION

According to a first aspect of the invention a sunscreen storage device is provided, comprising a timer.

Preferably, the timer comprises an alarm.

Preferably, the timer comprises a digital display.

Preferably, the alarm is audible.

Preferably, the alarm is visible.

Preferably, the alarm is adapted to vibrate.

Advantageously, a time period can be readily set to remind the user to reapply sunscreen, once or at regular intervals.

Preferably, the timer comprises at least one quick-set system allowing it to be readily set to count down a fixed period of time.

Preferably, the quick-set system comprises at least one button which allows the timer to be activated.

Advantageously, frequently used time period(s) may be set quickly and readily.

Preferably, the sunscreen storage device further comprises a sunscreen receptacle.

Advantageously, the sunscreen storage device may be used to removably receive and store sunscreen. Thus, the sunscreen storage device may be refilled with additional or new sunscreen.

Preferably, the sunscreen receptacle is adapted to receive a compacted powder sunscreen.

Advantageously, a child may more easily apply the sunscreen without getting it in their eyes.

Preferably, the sunscreen storage device further comprises a housing adapted to removably receive a sunscreen applicator.

Advantageously, the sunscreen may be available as standard pallets and hygienically replaced or refilled on demand.

Preferably, the sunscreen storage device further comprises a sunscreen applicator taking the form of a sponge.

Advantageously, the sunscreen may be easily, cosmetically and hygienically applied to the face, neck and ears, as well as other parts of the body exposed to the sun, with minimal spillage and/or wastage.

Preferably, the sunscreen storage device further comprises a mirror.

Advantageously, the sunscreen may be accurately applied.

Preferably, the sunscreen storage device further comprises a clip, the clip being adapted to removably attach the sunscreen storage device to other objects.

Preferably, the clip comprises a looped structure which is hingedly configurable between a first configuration and a second configuration, the looped structure providing a carabeena-type attachment in the first configuration and a clamping-type attachment in the second configuration.

Advantageously, the sunscreen storage device may be attached to other objects (such as a backpack, handbag, belt, belt loop or pocket) for ease of access and to reduce the risk of misplacement or loss. The ability of the clip to be configurable between two configurations allows the sunscreen storage device to be removably attached to a larger range of objects. For example, in the first configuration, the sunscreen storage device may be removably attached to objects with loops or holes, and in the second configuration, the device may be removably attached to objects that have a relatively thin and flat portion. Preferably, the sunscreen storage device further comprises a power source for powering one or more electronic or analogue functions in the sunscreen storage device.

Advantageously, the power source may be an internal power source such as a battery or an external power source such as an AC or DC power supply. The power source may also be a solar panel comprising one or more solar or photovoltaic cells for converting sunlight into electrical power to power the sunscreen storage device.

Preferably, the sunscreen storage device further comprises one or more speakers.

More preferably, the one or more speakers are adapted for audibly relaying the alarm.

Preferably, the one or more speakers are adapted for audibly relaying an information report.

More preferably, the information report may include a UV Index report, a weather report or a temperature report.

Advantageously, the speakers enable the alarm or weather report to be relayed audibly to the user to remind them to apply more sunscreen.

Preferably, the sunscreen storage device further comprises a note receptacle for receiving a note.

Advantageously, the sunscreen storage device may store at least one piece of paper, for example, a note, giving parental permission for a child to use the device or apply sunscreen at school.

Preferably, the sunscreen storage device further comprises a label receptacle for receiving a label.

Advantageously, the sunscreen storage device may store at least one label, for example, a nametag, to indicate to whom the device belongs. The label may be a permanent label, or temporary label.

Other aspects of the invention are also disclosed.

### BRIEF DESCRIPTION OF THE DRAWINGS

Notwithstanding any other forms which may fall within the scope of the present invention, a preferred embodiment of the invention will now be described, by way of example only, with reference to the accompanying drawings in which:

FIG. 1 is a front elevational view of a sunscreen storage device in accordance with an exemplary embodiment of the present invention, showing a body in a closed configuration and a clip in a first configuration;

FIG. 2 is a rear elevational view of the sunscreen storage device of FIG. 1, showing the body in the closed configuration and the clip in a second configuration;

FIG. 3 is a perspective view of the sunscreen storage device of FIG. 1, showing the body in an open configuration and the clip in the second configuration;

FIG. 4 is a side elevational view of the sunscreen storage device of FIG. 1, showing the body in the closed configuration and the clip in the second configuration;

FIG. 5 is a front elevational view of a sunscreen storage device in accordance with a further exemplary embodiment of the present invention, showing a body in a closed configuration and a clip in a first configuration; and

FIG. 6 is a perspective view of the sunscreen storage device of FIG. 5, showing the body in an open configuration and the clip in a second configuration.

### DETAILED DESCRIPTION OF SPECIFIC EMBODIMENTS

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention.

Before the present invention is disclosed and described, it is to be understood that the terminology used herein is for the purpose of describing particular embodiments only and is not intended to be limiting. It must be noted that, as used in the specification and the appended claims, the singular forms “a,” “an,” and “the” include plural references unless the context clearly dictates otherwise.

While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

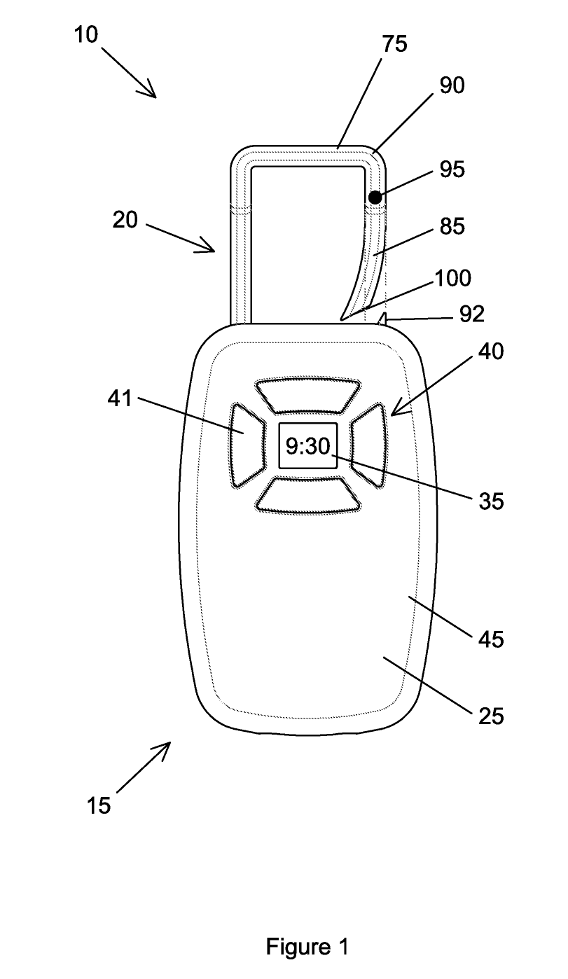

Referring to FIGS. 1 to 4, a sunscreen storage device 10 is provided and may be used to removably store compacted powder sunscreen contained within pallets. It should be noted that the sunscreen storage device 10 may also be used to store other objects or alternative forms of sunscreen.

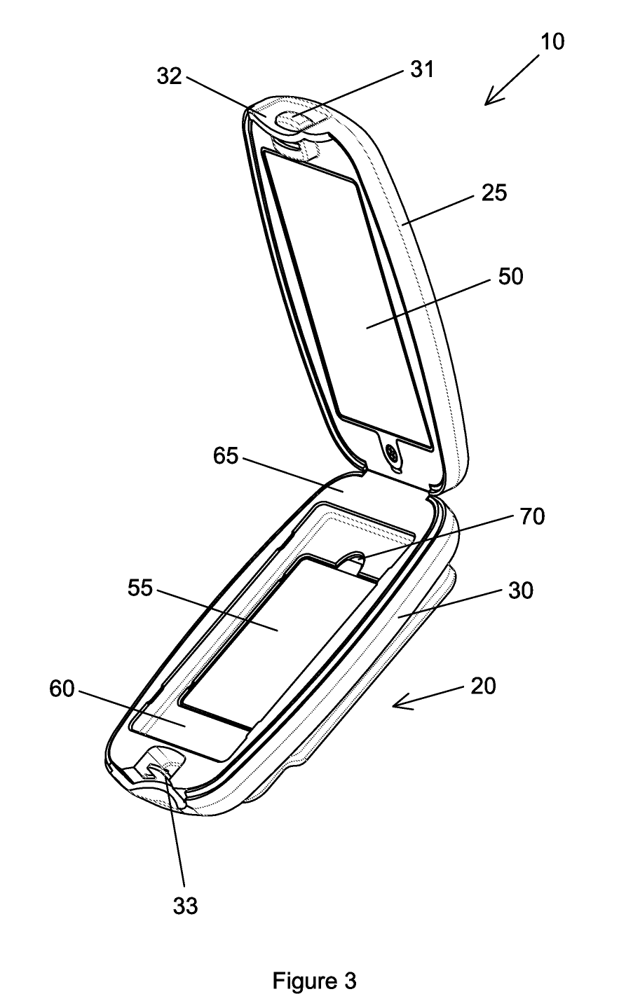

The sunscreen storage device 10 comprises a body 15 and a clip 20. The body 15 has a lid 25 that is hingedly connected to a base 30 (see FIG. 3) and is adapted to be readily opened and closed. The sunscreen storage device 10 is shown in a closed configuration in FIGS. 1, 2 and 4 and in an open configuration in FIG. 3. When closed, the lid 25 covers a top surface of the base 30. The lid 25 and base 30 have a generally oval shape when viewed from the top. In another embodiment, the lid 25 and base 30 may have another shape when viewed from the top. For example, the lid 25 and base 30 may be rectangular or hexagonal.

In this embodiment, the lid 25 having a first latching portion 32 is adapted to be securely engaged with the base 30 having a fixing portion 33 by virtue of a spring latch that is releasable by the pressing of a button 31. It should be noted that the lid 25 may be adapted to be securely engaged with the base 30 by a number of other means, for example a clip.

In this embodiment, the sunscreen storage device 10 may further comprise any suitable power source (not shown) to power one or more electronic or analogue functions of the sunscreen storage device 10. For example, the power source may be an internal power source such as a battery (not shown) or an external power source such as an AC or DC power supply. Preferably, the internal power source comprises one or more batteries. For example, the one or more batteries may be alkaline batteries or rechargeable batteries (also known as storage batteries or secondary cells). It will also be appreciated by persons skilled in the art that the power source may be a solar panel for converting sunlight into electrical power. The solar panel may comprise one or more solar or photovoltaic cells for converting sunlight into electrical power to power the sunscreen storage device 10. For example, the solar panel may be configured for supplying power to the sunscreen storage device 10 directly, or configured for supplying recharge power to a rechargeable battery power source within the sunscreen storage device 10.

A timer is located within the lid 25 and has a digital display 35 which is flush with an exterior surface of the lid 25 and displays a time. Preferably, the timer is powered by the power source. An analogue display may also or alternatively be used to display the time. The timer further comprises a quick-set system 40, which, in this embodiment, has four buttons 41. Pressing any one of the four buttons 41 sets the timer to be set to count down a fixed period of time. For example, pressing one of the buttons 41 sets the timer to count down twenty minutes, pressing another button 41 sets the timer to count down one hour, and so on. The timer further comprises an alarm to notify the user when the set period of time has elapsed. The alarm may be deactivated by pressing any one of the buttons 41 of the quick-set system 40. In this embodiment, the alarm takes the form of a flashing digital display 35 by virtue of flashing LED lights arranged within the timer. However, it should be noted that the alarm may also or alternatively be adapted to notify the user of an elapsed time by audible tones or vibration. For example, the alarm may be adapted to notify the user for a specified period of time, and then if the user is not alerted to the alarm, the alarm may repeat until the timer is reset or deactivated. The alarm may also be adapted to notify the user at different intervals, for example, prewarn the user of a pending time to apply more sunscreen, and then notify the user again when this time has elapsed. If the user is unable to hear the audible tones of the alarm, the alarm may be adapted, for example, to increase in volume and/or to flash or vibrate to catch the user's attention. In this embodiment, the lid 25 further includes an inlaid, domed decorative exterior 45.

The quick-set system 40 may comprise any number of buttons 41 for triggering different functions. For example, a more basic version of the sunscreen storage device 10 may comprise a quick-set system 40 having less than four buttons 41, while a more advanced version may comprise a quick-set system 40 having more than four buttons 41.

One or more of these buttons 41 may be programmed to have one or more functions. For example, one button 41 may be programmed with an ON and OFF function, or alternatively, this button 41 may simply be programmed with an ON function, and one of the other buttons 41 programmed with an OFF function. Buttons 41 may also be programmed with additional functions that may include, but are not limited to controlling any one or more of the following: a flashing LED light; an audible alarm. Such additional functions may introduce extra sound options and/or different light options to alert the user to, for example, apply more sunscreen. The extra sound options, for instance, may be as simple as a series of one or more beeps to perhaps emitting a musical tune.

An advanced version of the sunscreen storage device 10 may comprise additional LED or LCD display elements to visually alert the user to apply more sunscreen as well as enable the user to play games, for example, games that may be programmed to raise a user's awareness of the harmful effects of the sun. The additional LED or LCD display elements of the sunscreen storage device 10 may also display information, such as, for example, the current time, the current date, a calendar, a calculator. The one or more functions of the calendar and calculator may be operated by, for example, programming one or more of the buttons 41 to perform such functions. The additional LED or LCD display elements may also display one or more icons to visually represent the condition of the one or more functions of the sunscreen storage device 10. Such icons may include, for example, a power level meter (not shown), such as a battery life indicator to indicate the level of power remaining in the battery power source (not shown); an icon to indicate the volume level of the alarm; an icon such as a speaker icon, to indicate that the alarm is, for example, activated, deactivated, or muted; an icon to indicate that the alarm is in vibration mode or flash mode.

The sunscreen storage device 10 may also comprise a receiver (not shown) to receive, for example, information reports such as daily UV index reports, weather reports, temperature reports, and/or other information that may then be displayed visually on an LED or LCD display or relayed audibly via any suitable measures. Such a receiver may include but is not limited to any one of the following devices: a radio; a pager. The LED or LCD display elements may also display icons to indicate that, for example, an information report has been received. The sunscreen storage device 10 may also comprise a system (not shown) for playing music. Such a system may facilitate the playback of music using any one of a number of media formats, including but not limited to any one or more of the following: MP3; MP4; WMA; WAV; AVI; ATRAC; AAC; FLAC. It will be appreciated that the sunscreen storage system 10 may also include additional functions associated with such a system, for example, but not limited to: a volume control; a mute control; one or more speakers to audibly relay music or an audible alarm; an earphone socket (not shown) for insertion of an earphone or headphone plug; one or more ports (not shown), for example: a mini USB port, a USB port; a port for receiving (not shown), for example, a non-volatile or flash memory card. Activating the volume control or mute control, for example, to increase or decrease the volume, or mute the audible alarm or music, respectively, may be visually represented on the LED or LCD display elements using the corresponding icon described above.

Referring specifically to FIG. 3, an interior portion of the lid 25 comprises an inlaid and recessed shatter-proof mirror 50. An interior portion of the base 30 comprises a sunscreen receptacle 55 that is adapted to receive and hold a pallet of compact powder sunscreen, and a sunscreen applicator housing 60 that is adapted to receive and house a sunscreen applicator, for example, a sponge. The sunscreen applicator housing 60 is inlaid into an interior (top) surface 65 of the base 30 and the sunscreen receptacle 55 is inlaid into the sunscreen applicator housing 60. The sunscreen applicator housing 60 further comprises a relatively small cavity 70 located directly adjacent to an edge of the sunscreen receptacle 55. The cavity 70 facilitates easy fitting and removal of a pallet of compact powder sunscreen as this allows a finger or implement to be located therewithin to pry the pallet out of the receptacle 55. It will be appreciated by persons skilled in the art that the sunscreen storage device 10 is not limited to storing only sunscreen in powder form but that sunscreen in other forms may be stored. Sunscreen in other forms may include, for example, but are not limited to any one or more of the following: a lotion; a cream; wipes impregnated with sunscreen. It will also be appreciated that the sunscreen storage device 10 may be adapted to house a bottle for containing sunscreen, where the bottle may comprise sunscreen in lotion form or liquid form, which may be applied to the user's skin using, for example, a spray applicator, or simply by applying the sunscreen with a sponge applicator. The sunscreen storage device 10 may also be adapted to house a sunscreen stick.

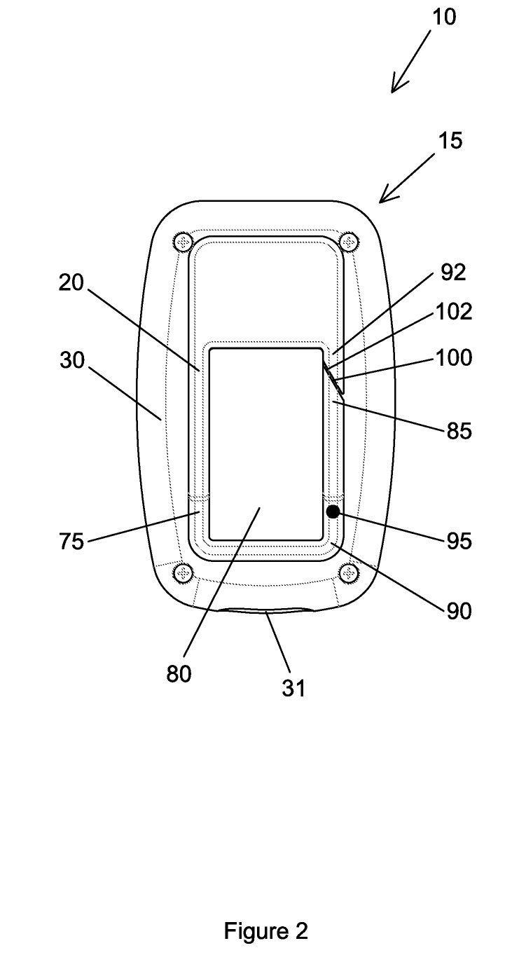

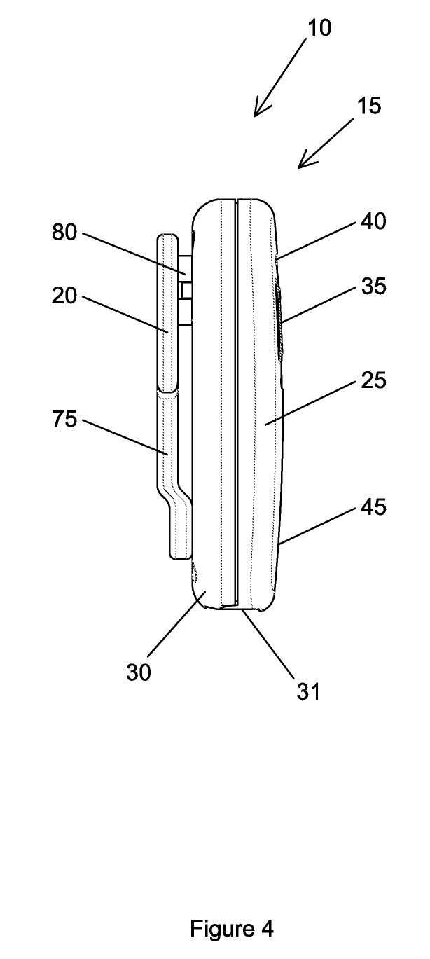

The clip 20 is adapted to removably attach the sunscreen storage device 10 to other objects. It has a looped U-shaped structure 75, which is hingedly configurable, by virtue of a hinge joint 80, between a first and a second configuration. The clip 20 is shown in a first configuration in FIG. 1 and in a second configuration in FIGS. 2 and 4. In the first configuration, the clip 20 is extended to provide a carabeena-type (also, carabiner or karabiner) attachment by virtue of a movable gate portion 85 of the U-shaped structure 75. The gate portion 85 having a first end and a second end 100 is pivotally attached at the first end to a first terminal portion 90 of the U-shaped structure 75 by virtue of a pin joint 95 for arcuate movement of the second end 100 toward and away from a second terminal portion 92 of the U-shaped structure 75. The gate portion 85 may be pivoted toward a central region of the U-shaped structure 75 (inwardly) to selectively create or close an opening. Thus, an object or part of an object may be located within or removed from a central region of the U-shaped structure 75. The second end 100 of the gate portion 85 has an angled end-surface corresponding to a similarly angled end surface 102 of the second terminal portion 92, such that the gate portion 85 is prevented from being pivoted away from the central region of the U-shaped structure 75 (outwardly). The end surfaces are adapted to mate and secure the gate portion 85 in the closed configuration. Referring to FIG. 1, the gate portion 85 is shown (in bold lines) in an open configuration. The gate portion 85 in a closed configuration is shown in phantom lines.

In the second configuration, the clip 20 is folded such that the U-shaped structure 75 is located adjacent to a flat undersurface of the base 30. Thus, an object or part of an object, for example a shirt pocket or belt, may be sandwiched between the flat undersurface and the U-shaped structure 75 and secured therebetween.

A main advantage of the sunscreen storage device 10 is that time periods can be readily set to remind the user to reapply sunscreen, once or at regular intervals. This is especially desirable since the maintenance of the effectiveness of sunscreen protection relies on reapplication. The flashing lights, audible tones and/or vibration of the alarm remind the user, particularly if the user is a child, to reapply sunscreen in a variety of situations. Furthermore, the provision of the quick-set system 40 allows frequently used time period(s) to be set quickly and readily. The design of such a system 40 also allows young children and those who are unfamiliar with technology to be able to operate the device 10.

The sunscreen storage device 10 is reusable and is intended to be used to removably receive and store sunscreen. Thus, the sunscreen storage device 10 may be refilled with additional or new sunscreen pallets or refills, as required. This minimizes the amount of waste generated and allows the sunscreen to be frequently replaced, if desired, for hygiene considerations or if the refill has been exhausted.

The decorative exterior 45 makes the sunscreen storage device 10 more aesthetically pleasing and potentially more appealing, especially to children and young adults. The exterior may be decorated in different colors and designs to suit different users.

The provision of a sunscreen applicator, applicator housing 60 and mirror 50 advantageously allows the sunscreen to be easily, cosmetically, accurately and hygienically applied to the face, neck and ears, as well as any other parts of the body exposed to the sun, with minimal spillage and/or wastage.

The clip 20 allows the sunscreen storage device 10 to be attached to other objects (such as a backpack, handbag, belt, belt loop or pocket) for ease of access and to reduce the risk of misplacement or loss. The ability of the clip 20 to be configurable between two configurations allows the sunscreen storage device 10 to be attached to a larger range of objects. For example, in the first configuration, the sunscreen storage device 10 may be attached to objects with loops or holes (for example, a bag zipper), and in the second configuration, the device 10 may be attached to objects that have a flat portion (for example, a belt or a shirt pocket).

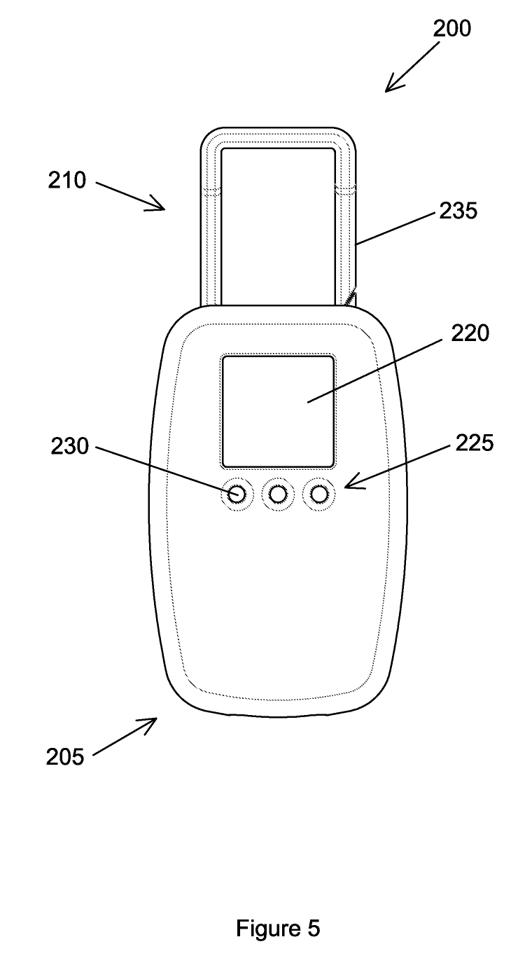

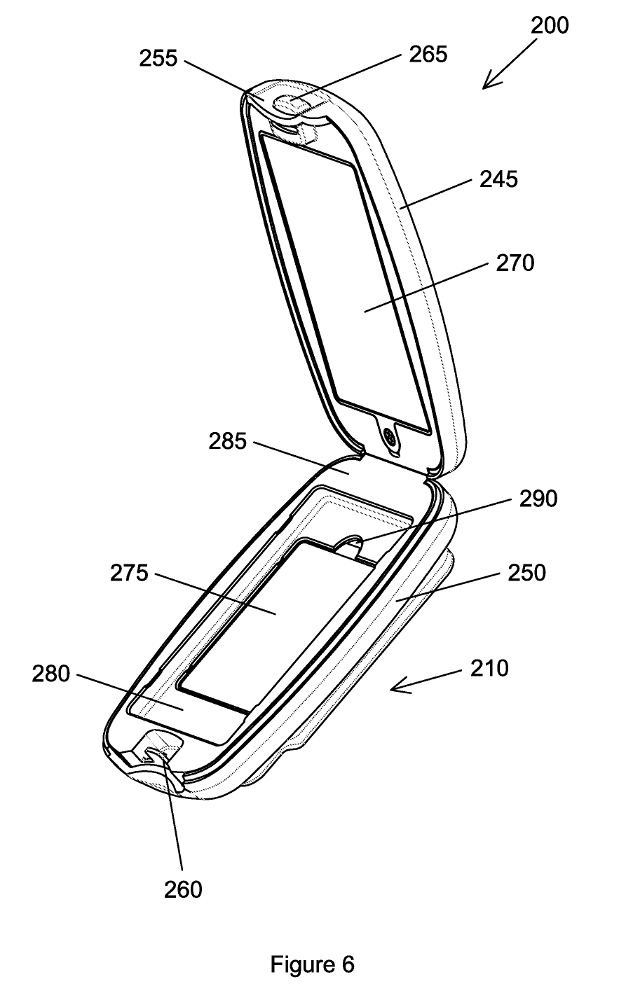

Referring to FIGS. 5 to 6, a further embodiment of a sunscreen storage device 200 is provided and may be used to removably store compacted powder sunscreen contained within pallets. It should be noted that the sunscreen storage device 200 may also be used to store other objects or alternative forms of sunscreen.

The sunscreen storage device 200 comprises a body 205 and a clip 210. The body 205 has a lid 245 that is hingedly connected to a base 250 (see FIG. 6) and is adapted to be readily opened and closed. The sunscreen storage device 200 is shown in a closed configuration in FIG. 5, and in an open configuration in FIG. 6. When closed, the lid 245 covers a top surface 285 of the base 250. The lid 245 and base 250 have a generally oval shape when viewed from the top.

In this embodiment, the lid 245 having a first latching portion 255 is adapted to be securely engaged with the base 250 having a fixing portion 260 by virtue of a spring latch that is releasable by the pressing of a button 265. It should be noted that the lid 245 may be adapted to be securely engaged with the base 250 by a number of other measures, for example a clip.

Referring specifically to FIG. 6, an interior portion of the lid 245 comprises an inlaid and recessed shatter-proof mirror 270. An interior portion of the base 250 comprises a sunscreen receptacle 275 that is adapted to receive and hold a pallet of compact powder sunscreen (not shown), and a sunscreen applicator housing 280 that is adapted to receive and house a sunscreen applicator, for example, a sponge (not shown). The sunscreen applicator housing 280 is inlaid into an interior (top) surface 285 of the base 250 and the sunscreen receptacle 285 is inlaid into the sunscreen applicator housing 280. The sunscreen applicator housing 280 further comprises a relatively small cavity 290 located directly adjacent to an edge of the sunscreen receptacle 275. The cavity 290 facilitates easy fitting and removal of a pallet of compact powder sunscreen as this allows a finger or implement to be located therewithin to pry the pallet out of the receptacle 275.

A timer is located within the lid 245 and has a digital display 220 which is flush with an exterior surface of the lid 245 and displays a time (not shown). Preferably the timer is powered by any suitable power source. An analog display may also or alternatively be used to display the time. The timer further comprises a quick-set system 225, which, in this embodiment, has three buttons 230.

In this embodiment, each of the three buttons 230 are preferably programmed with one of the following functions: an ON and OFF function, a timer SET/CANCEL function, and a MUTE control. For example, pressing the timer SET/CANCEL button 230 sets the timer to be set to count down a fixed period of time. Pressing the timer SET/CANCEL button 230 again cancels the timer countdown. One or more of the three buttons 230 may be programmed to have one or more functions. For example, one button 230 may be programmed with an ON and OFF function, or alternatively, this button 230 may simply be programmed with an ON function, and one of the other buttons 230 programmed with an OFF function. Buttons 230 may also be programmed with additional functions that may include, but are not limited to, for example, controlling: a flashing LED light; an audible alarm.

While the invention has been described with reference to a number of preferred embodiments it should be appreciated that the invention can be embodied in many other forms. For example, in another embodiment the body 15 may comprise a note receptacle for receiving and storing a note, such as a permission note, to allow a child to apply sunscreen at school. In a further embodiment, the body 15 may comprise a label receptacle for receiving a label, such as a nametag, to indicate to whom the sunscreen storage device 10 belongs. The label may be a permanent label or temporary label.

In another embodiment, the timer can be set to count down any appropriate period of time.

In yet another embodiment, the sunscreen receptacle is adapted to receive a sunscreen having a solid cream base.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment.

Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

It is apparent from the above, that the arrangements described are applicable to the sun protection and cosmetics industries.

The foregoing description and accompanying drawings illustrate the principles, preferred embodiments and modes of operation of the invention. More specifically, the encrypted identification systems and methods according to the present invention have been described with respect to an inventory system and process. However, the invention should not be construed as being limited to the particular embodiments discussed above. Additional variations of the embodiments discussed above will be appreciated by those skilled in the art as well as for applications, unrelated to inventory, that require encrypted identification of parts.

The above-described embodiments should be regarded as illustrative rather than restrictive. Accordingly, it should be appreciated that variations to those embodiments can be made by those skilled in the art without departing from the scope of the invention as defined by the following claims.

I claim:

1. A sunscreen storage device comprising a timer.

2. A sunscreen storage device as claimed in claim 1, wherein the timer comprises an alarm.

3. A sunscreen storage device as claimed in claim 1, wherein the timer comprises a digital display.

4. A sunscreen storage device as claimed in claim 2, wherein the alarm is audible.

5. A sunscreen storage device as claimed in claim 2, wherein the alarm is visible.

6. A sunscreen storage device as claimed in claim 2, wherein the alarm is adapted to vibrate.

7. A sunscreen storage device as claimed in claim 1, wherein the timer comprises at least one quick-set system allowing it to be readily set to count down a fixed period of time.

8. A sunscreen storage device as claimed in claim 7, wherein the quick-set system comprises at least one button which allows the timer to be activated.

9. A sunscreen storage device as claimed in claim 1, further comprising a sunscreen receptacle.

10. A sunscreen storage device as claimed in claim 9, wherein the sunscreen receptacle is adapted to receive a compacted powder sunscreen.

11. A sunscreen storage device as claimed in claim 1, further comprising a housing adapted to removably receive a sunscreen applicator.

12. A sunscreen storage device as claimed in claim 11, further comprising a sunscreen applicator taking the form of a sponge.

13. A sunscreen storage device as claimed in claim 1, further comprising a mirror.

14. A sunscreen storage device as claimed in claim 1, further comprising a clip, the clip being adapted to removably attach the sunscreen storage device to other objects.

15. A sunscreen storage device as claimed in claim 14, wherein the clip comprises a looped structure which is hingedly configurable between a first configuration and a second configuration, the looped structure providing a carabeena-type attachment in the first configuration and a clamping-type attachment in the second configuration.

16. A sunscreen storage device as claimed in claim 1, further comprising a power source for powering one or more electronic or analog functions in the sunscreen storage device.

17. A sunscreen storage device as claimed in claim 1, further comprising one or more speakers.

18. A sunscreen storage device as claimed in claim 2, further comprising one or more speakers adapted for audibly relaying the alarm.

19. A sunscreen storage device as claimed in claim 17, wherein the one or more speakers are adapted for audibly relaying an information report.

20. A sunscreen storage device as claimed in claim 19, wherein the information report may include a UV Index report, a weather report or a temperature report.

21. A sunscreen storage device as claimed in claim 1, further comprising a note receptacle for receiving a note.

22. A sunscreen storage device as claimed in claim 1, further comprising a label receptacle for receiving a label.

23. (canceled)

24. A sunscreen device, comprising:
a body defining a sunscreen storage chamber;
a sunscreen removably disposed in the sunscreen storage chamber; and
a timer connected to the body and having an alarm selected from at least one of a visual alarm, an audible alarm, and a vibratory alarm.
